(19) United States
(12) Patent Application Publication
(10) Pub. No.: US 2023/0040800 A1
(43) Pub. Date: Feb. 9, 2023

(54) METHOD FOR PRODUCING A HYBRID COMPONENT

(71) Applicant: Mahle International GmbH, Stuttgart (DE)

(72) Inventors: Tilo Hentschel, Hattenhofen (DE); Justus Himstedt, Stuttgart (DE); Hendrik De Keyser, Deinze (BE); Antonio Menonna, Ditzingen (DE); Luis Neumann, Schorndorf (DE); Falk Schneider, Gerlingen (DE)

(21) Appl. No.: 17/883,591

(22) Filed: Aug. 8, 2022

(30) Foreign Application Priority Data
Aug. 9, 2021 (DE) 102021208630.6

(51) Int. Cl. B29C 45/14

(52) U.S. Cl. CPC B29C 45/14311; B29K 2101/10

(57) ABSTRACT

A method for producing a hybrid component may include placing a metallic insert part into an injection mould, at least one of over-moulding and back-injecting the metallic insert part with a plastic mass, and pretreating a surface of the metallic insert part that is to be at least one of over-moulded and back-injected prior to the at least one of over-moulding and back-injecting. The metallic insert part may be placed into the injection mould such that the metallic insert part protrudes from the plastic mass on at least one side. A material accumulation may be disposed on a transition region from the metallic insert part to the plastic mass.

### CROSS-REFERENCE TO RELATED APPLICATIONS

This application claims priority to German Patent Application No. DE 10 2021 208 630.6, filed on Aug. 9, 2021, the contents of which is hereby incorporated by reference in its entirety.

### TECHNICAL FIELD

The present invention relates to a method for producing a hybrid component, in which an insert part made of metal is placed into an injection mould and over-moulded and/or back-injected with a plastic mass. In addition, the invention relates to a hybrid component produced according to this method.

### BACKGROUND

From DE 103 277 769 A1 a generic method for producing a hybrid component is known, in which at least one part region of a surface of an insert part made of metal is over-moulded or back-injected with plastic in a moulding space of an injection mould. Before the over-moulding or back-injecting, a sealing bead is applied, at least on a part circumference of the part region of the insert part to be over-moulded or back-injected, to the surface of the inserted part or to the sealing edges of the injection mould delimiting the moulding space. By way of this, in particular an over-moulding of the insert part with the plastic mass and if applicable damage to a coating of the insert part is to be avoided.

In particular in modern vehicle construction it has already been known for a long time to mount attachment parts to plastic components, wherein for a reliable mounting insert parts injection-moulded into a plastic mass of the plastic component, so-called inserts, or pressed-in screw elements are used. However, this is technically complicated and therefore cost-intensive, in particular with respect to forming screw domes and joint lines.

A further disadvantage in using such insert parts consists in connecting errors which can occur in the production process, i.e. during the over-moulding or back-injecting of the insert part, for example by dirt. A less than perfect connection of the insert part with the plastic mass can result in particular in cracks and, in the case of fluid-conducting components, in leakages.

### SUMMARY

The present invention therefore deals with the problem of stating for a method of the generic type an improved or at least an alternative embodiment which overcomes in particular the disadvantages known from the prior art.

According to the invention, this problem is solved through the subject matter of the independent claim(s). Advantageous embodiments are the subject matter of the dependent claim(s).

The present invention is based on the general idea of increasing in particular a tightness between an insert part injection-moulded into a plastic mass and the plastic mass in that in a transition region between the insert part and the plastic mass, from which the insert part protrudes from the plastic mass, an additional material accumulation and thus an enlargement of a sealing contact area is provided. With the method for producing a hybrid component according to the invention a coated or uncoated insert part made of metal is placed into an injection mould and over-moulded or back-injected with the previously described plastic mass, usually a thermosetting plastic. There, the insert part is pre-treated on a surface to be over-moulded or back-injected prior to the over-moulding or back-injecting in order to improve a connection with the plastic mass and thus a tightness. Following this, the insert part is placed in the injection mould so that it protrudes from the plastic mass on at least one side. At a transition region between the insert part protruding from the plastic mass and the plastic mass, a material accumulation is now provided according to the invention, which can be realised for example with a comparatively small pocket or cavity in the injection mould. By way of this material accumulation, the contact area of the insert part that is in contact with the plastic mass and by way of this the tightness can be increased. For example mounting parts or components for mounting further components such as for example a pump tappet can be employed as insert parts. The at least one insert part can protrude from the future injection-moulded part or hybrid component on the left, on the right, at the top or at the bottom. The insert part or the insert parts however are not completely enclosed or over-moulded by the thermosetting plastic. By way of the pre-treatment of the surface that is in contact with the plastic mass, greater adhesion forces can be achieved and thereby the sealing effect improved.

In an advantageous further development of the method according to the invention, the insert part is cleaned and/or degreased on a surface to be over-moulded or back-injected prior to the over-moulding or back-injecting. Cleaning or degreasing can take place for example by way of suitable chemical means.

Practically, a casting, a ceramic part, an aluminium part, a sintered part or a sheet metal part is used as metallic insert part. Here, the insert part can be formed solid or as a hollow part and have almost any shape, for example round, half-round, angular, etc. Obviously, composite insert parts consisting of multiple materials can also be employed. By way of the metallic insert part a reliable connection for example of further attachment components with the hybrid component largely consisting of plastic is possible, just as the mounting of further components, such as for example a pump tappet, which is guided in a suitably formed metallic insert part. A similar guide in plastic would not be possible because of excessive wear. Even the previously mentioned and non-conclusive enumeration gives an idea of the manifold embodiments that are possible for the metallic insert part. Thus, the method according to the invention is suitable for a multiplicity of very different insert parts.

In a further advantageous embodiment of the method according to the invention, the insert part is roughened on the surface to be over-moulded or back-injected prior to the over-moulding or back-injecting. By way of the roughing, which can take place for example by a blasting, in particular a shotblasting, sandblasting, etc. or a grinding, the surface that will come into contact with the future plastic mass during the over-moulding or back-injecting is increased, as a result of which higher adhesion forces and a better sealing can be achieved. Alternatively, a pickling is obviously also possible, which removes in particular oxide coatings such as for example rust or corrosion products. During a pickling, a protection against oxidation of the surface to be over-moulded or back-injected later on can be additionally achieved. For example hydrochloric acid or sulphuric acid can be used as pickle.

In a further advantageous embodiment of the method according to the invention, the insert part is plasma-treated on a surface to be over-moulded or back-injected prior to the over-moulding or back-injecting and subsequently coated, in particular with a DLC coat (diamond light carbon). Plasma refers to the fourth physical state that is attained provided that a sufficient amount of energy, for example in the form of electric energy, is added to a gas or gas mixture. Free ions and electrons develop in the process which can be utilised for cleaning the surface to be over-moulded or back-injected later on. However, not only a surface cleaning is possible with the plasma treatment but also a change of the surface characteristics, as a result of which a particularly high-adhesion and corrosion-resistant, since tight, connection between the insert part and the plastic mass can be achieved. Particularly preferably, the insert part is initially plasma-treated on the surface to be over-moulded or back-injected and subsequently coated in the same machine without the surface to be over-moulded or back-injected entering into contact with the surroundings beforehand. By way of this, an undesirable oxidation of the surface to be over-moulded or back-injected in particular in the case of insert parts produced from aluminium can be avoided and a high adhesion ensured.

Practically, the insert part comprises honeycomb-shaped recesses with a depth T of 0.1 mm≤T≤0.3 mm on the surface to be over-moulded or back-injected. The plastic mass can enter into these honeycomb-shaped recesses and bring about a better interlocking with the surface. Obviously, further undercut contours can also be provided on the insert part which contribute to enlarging the over-moulded or back-injected surface coming into contact with the plastic mass, for example in the manner of a labyrinth seal and thereby increase the sealing effect. The stated depth range between 0.1 and 0.3 mm is already sufficient to enlarge the surface and increase the sealing or adhesion effect.

Practically, the insert part protrudes from the plastic mass at an angle α between 60° and 90°. Particularly in this angular range, the method according to the invention, with the provision of a material accumulation at the transition region between insert part and plastic mass, represents an efficient method of increasing the sealing effect between plastic and insert part.

Further, the present invention is based on the general idea of producing a hybrid part according to the method described in the preceding paragraphs and thereby transfer the advantages described in the preceding paragraphs to the hybrid component. Here, the hybrid component can be designed as a pump part or as cylinder head cover, while the insert part is a guide for a pump tappet.

The cylinder head cover is produced for the greatest part from thermosetting plastic in the injection mould and has at least one insert part which was placed into the injection mould so that it protrudes from the plastic mass on at least one side and at the same time has a material accumulation at a transition region, at which the insert part protrudes from the plastic mass. The material accumulation of plastic can be achieved for example through a suitable cavity or pocket in the injection mould. The hybrid component formed as cylinder head cover according to the invention and the insert part injection-moulded therein and formed as guide for a pump tappet make it possible to guide such a pump tappet of a pump, for example of a lubricant or fuel or coolant pump on a cylinder head cover formed from plastic so as to operate smoothly and with at least low wear in the long-term. To date, this was only possible for cylinder head covers formed for example from aluminium since the sealing effect and longevity of the connection between insert part and plastic mass required for this purpose was not achieved with cylinder head covers made of plastic without material accumulation in the past.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

There it shows, in each case schematically,

FIG. 1 shows a sectional representation through a hybrid component according to the invention produced in accordance with a method according to the invention,

FIG. 2 shows a sectional representation through an internal combustion engine in the region of a cylinder head cover formed as hybrid component according to the invention in accordance with the method according to the invention.

### DETAILED DESCRIPTION

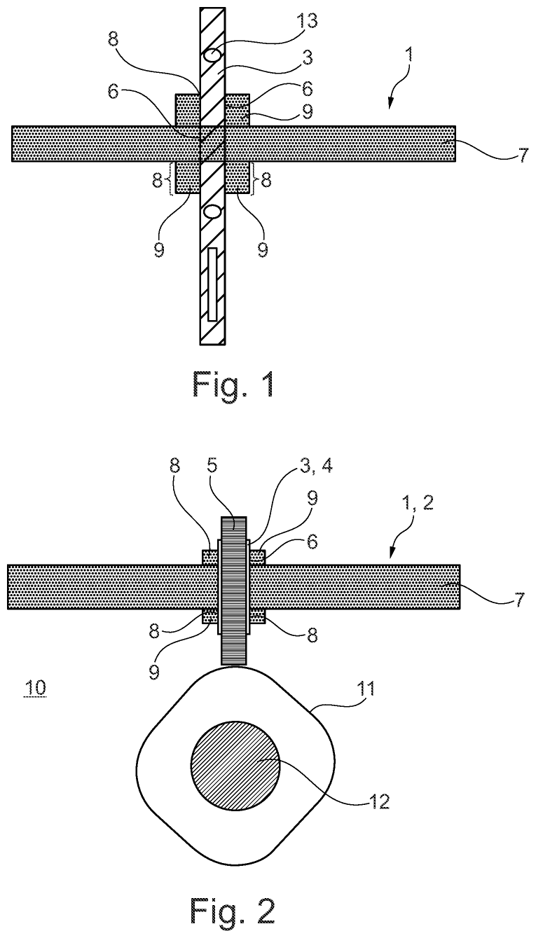

According to FIGS. 1 and 2, a hybrid component 1 according to the invention is shown, which according to FIG. 2 is formed as cylinder head cover 2. The hybrid component 1 according to the invention has at least one coated or uncoated insert part 3 made of metal, which according to FIG. 2 is formed as guide 4 for a pump tappet 5. The pump tappet 5 is moved during the operation of an internal combustion engine 10 equipped with the cylinder head cover 2 according to the invention by way of a rotating cam 11. The cam 11 is non-rotatably connected to a shaft 12, for example a camshaft.

The hybrid component 1 according to the invention, respectively the cylinder head cover 2, is produced as follows:

Initially, the insert part 3, according to FIG. 2 the guide 4, is pre-treated, for example roughened on a surface 6 to be over-moulded or back-injected prior to the over-moulding or back-injecting. Following this, the insert part 3, respectively the guide 4, is placed into the injection mould in such a manner that it protrudes on at least one side from a plastic mass 7 to be produced or injected during the injection moulding process. At a transition region 8 from the insert part 3 or the guide 4 to the plastic mass 7, a material accumulation 9 is now provided, which enlarges the surface 6 to be over-moulded or back-injected, i.e. a contact area with the plastic mass 7. By way of this, a tightness and also a strength of the connection can be increased in particular.

The insert part 3 or the guide 4 is cleaned and/or degreased on the surface 6 to be over-moulded or back-injected prior to the over-moulding or back-injecting. This can take place for example by means of a plasma treatment or a chemical treatment. For example a casting, a ceramic part, an aluminium part, a sintered part or a sheet metal part can be used as metallic insert part 3. In particular, the metallic insert part 3 can be formed solid (see FIG. 1) or as a hollow part (see FIG. 2). Usually, a thermosetting plastic is used as plastic mass 7 for the plastic injection moulding process.

The metallic insert part 3 can comprise cut-outs 13 on the surface to be over-moulded or back-injected and/or during the further course, wherein via the cut-outs 13 further attachment parts can be connected to the insert part 3. When the cut-outs 13 are provided or arranged in the region of the surface 6 to be over-moulded or back-injected, the plastic mass 7 can pass through the respective cut-out 13 during the injection moulding process and create a particularly stable connection.

Prior to the over-moulding or back-injecting in the injection mould, the surface 6 to be over-moulded or back-injected is roughened for example in order to thereby enlarge the surface 6 as a whole and achieve higher adhesion forces and a better sealing.

The cleaning of the surface 6 to be over-moulded or back-injected can be achieved for example by a grinding, polishing, blasting, plasma treating or pickling or chrome-plating. A chrome-plating offers the advantage to generate an increased roughness at the same time, as a result of which the mechanical interlocking is improved. A chrome-plating additionally increases the hardness and durability, prevents corrosion, creates an aesthetic appearance, facilitates cleaning operations on these parts and can additionally be applied to different plastic products which pursue a smooth/shining surface. Particularly a plasma-treating and a coating taking place in the same machine, for example by means of a DLC coat, without any contact with the atmosphere in the meantime, can reduce the risk of an oxidising of the surface, in particular in the case of aluminium insert parts, while on the surface 6 to be over-moulded or back-injected honeycomb-like recesses (not shown) with a depth T between 0.1 and 0.3 mm can also be provided, which bring about a better interlocking with the plastic mass 7. The insert part 3, respectively the guide 4, protrudes from the plastic mass 7 at an angle α between 60° and 90°.

By way of the method according to the invention with the material accumulations 9 provided according to the invention, the contact area between the metallic insert part 3, respectively the guide 4 (see FIG. 2) and the plastic mass 7 of the hybrid component 1, respectively the cylinder head cover 2, can be enlarged and thereby the tightness increased. A firmer anchorage of the metallic insert part 3 in the plastic mass 7 can also be achieved. Here, the plastic mass 7 and the material accumulation 8 are formed in one piece, provided that the material accumulation 9 is produced simultaneously with the plastic mass 7 during the injection moulding process. Purely theoretically it is also conceivable that initially the metallic insert part 3 is over-moulded or back-injected with the plastic mass 7 on the surfaces 6 to be over-moulded or back-injected and subsequently, in a further injection moulding operation, the material accumulations 9 are moulded on. Preferentially, this takes place however in a common operating step.

Particularly in the case of a cylinder head cover 2, as is shown according to FIG. 2, it is possible to firmly and tightly connect a metallic insert part 3 provided as guide 4 for a pump tappet 5 with the plastic mass 7 by way of the material accumulations 9 in the transition region 8. The plastic mass 7 is an integral part with the material accumulations 9, i.e. produced from one casting. To date, a guide of the pump tappets 5 has only been possible in metallic cylinder head covers since the sealing effect or strength of the anchorage required for this purpose was not possible with cylinder head covers injection moulded from plastic. The sealing between connected metal part and plastic cover is important for environmental protection reasons and for reducing the fire hazard, since leaking oil can ignite on a hot component, for example on an exhaust manifold. The particular challenge of a mounting for an injection pump are the high forces that have to be transmitted and the higher risk of leakage as a consequence of a connection weakness connected with this. In addition, an oil-contaminated engine compartment results from an oil leakage which can be attributable to the manufacturer of the cylinder head cover.

Here, the material accumulations 9 can be provided on both sides, as a result of which a significant enlargement of the surface 6 to be over-moulded or back-injected and thus of the surface 6 serving as contact area for the plastic mass 7 or the material accumulations 9 of the plastic mass 7 can be created.

1. A method for producing a hybrid component, comprising:
placing a metallic insert part into an injection mould;
at least one of over-moulding and back-injecting the metallic insert part with a plastic mass;
pretreating a surface of the metallic insert part that is to be at least one of over-moulded and back-injected prior to the at least one of over-moulding and back-injecting;
wherein the metallic insert part is placed into the injection mould such that the metallic insert part protrudes from the plastic mass on at least one side; and
wherein a material accumulation is disposed on a transition region from the metallic insert part to the plastic mass.

2. The method according to claim 1, wherein pretreating the surface of the metallic insert part includes at least one of cleaning and degreasing the surface to be at least one of over-moulded and back-injected.

3. The method according to claim 1, wherein the metallic insert part is configured as at least one of a casting, a ceramic part, an aluminium part, a sintered part, and a sheet metal part.

4. The method according to claim 1, wherein at least one of the plastic mass and the material accumulation includes a thermosetting plastic.

5. The method according to claim 1, wherein pretreating the surface of the metallic insert part includes roughening the surface to be at least one of over-moulded and back-injected.

6. The method according to claim 1, wherein the metallic insert part is at least one of pickled, ground, polished, blasted and chrome-plated on the surface to be at least one of over-moulded and back-injected prior to the at least one of over-moulding and back-injecting.

7. The method according to claim 1, wherein pretreating the surface of the metallic insert part includes plasma-treating and subsequently coating the surface to be at least one of over-moulded and back-injected.

8. The method according to claim 1, wherein the surface to be at least one of over-moulded and back-injected includes a plurality of honeycomb-like recesses with a depth of 0.1 mm to 0.3 mm.

9. The method according to claim 1, wherein the metallic insert part includes a plurality of cut-outs.

10. The method according to claim 1, wherein the metallic insert part protrudes from the plastic mass at an angle of 60° to 90°.

11. A hybrid component, produced according to the method of claim 1.

12. The hybrid component according to claim 11, wherein:
the hybrid component is a cylinder head cover; and
the metallic insert part is a guide for a pump tappet.

13. The method according to claim 1, wherein the metallic insert part is a non-hollow component.

14. The method according to claim 1, wherein the metallic insert part is a hollow component.

15. The method according to claim 1, wherein the surface to be at least one of over-moulded and back-injected includes a plurality of cut-outs.

16. The method according to claim 1, wherein pretreating the surface of the metallic insert part includes:
plasma-treating the surface to be at least one of over-moulded and back-injected; and
after plasma-treating the surface, coating the surface to be at least one of over-moulded and back-injected with a DLC coat.

17. A method for producing a hybrid component, comprising:
placing a metallic insert part into an injection mould;
pretreating a surface of the metallic insert part;
at least one of over-moulding and back-injecting at least the treated surface of the metallic insert part with a plastic mass;
wherein placing the metallic insert part into the injection mould includes arranging the metallic insert part in the injection mould such that, after the at least one of over-moulding and back-injecting, the metallic insert part protrudes from the plastic mass on at least one side; and
wherein at least one of over-moulding and back-injecting the metallic insert part includes forming a material accumulation in a transition region from the metallic insert part to the plastic mass.

18. The method according to claim 17, wherein the material accumulation is integrally formed with the plastic mass.

19. The method according to claim 17, wherein:
the surface of the metallic insert part includes at least one cut-out; and
at least one of over-moulding and back-injecting the metallic insert part further includes connecting the metallic insert part and the plastic mass via passing at least a portion of the plastic mass through the at least one cut-out of the treated surface.

20. The method according to claim 17, wherein at least one of over-moulding and back-injecting the metallic insert part further includes forming another material accumulation in the transition region on an opposite side of the plastic mass from the material accumulation.
